(19) United States
(12) Patent Application Publication
(10) Pub. No.: US 2014/0116197 A1
(43) Pub. Date: May 1, 2014

(54) DRIVING DEVICE AND CONTROL METHOD OF THE SAME

(71) Applicant: DENSO CORPORATION, Kariya-city (JP)

(72) Inventors: Yuuya TAKAHASHI, Tokai-city (JP); Yasuyoshi SUZUKI, Chiryu-city (JP); Toshihiro TAKAHARA, Kariya-city (JP); Shinichi SUGIURA, Kariya-city (JP); Atsushi ITO, Chiryu-city (JP)

(73) Assignee: DENSO CORPORATION, Kariya-city (JP)

(21) Appl. No.: 14/060,791

(22) Filed: Oct. 23, 2013

(30) Foreign Application Priority Data
Oct. 30, 2012 (JP) 2012-239327
Dec. 14, 2012 (JP) 2012-273349
Mar. 29, 2013 (JP) 2013-71867

(51) Int. Cl. F16H 53/02

(52) U.S. Cl. CPC F16H 53/025
USPC 74/567

(57) ABSTRACT

A driving device has a driving cam driven by a motor around a cam shaft, a roller which is in contact with the driving cam, a supporting frame, and a control shaft. The driving cam has a pocket portion. At the pocket portion, a profile distance from a center increases or decreases when the driving cam rotates in a normal direction or a reverse direction. When the pocket portion is in contact with the roller and the motor is stopped, the rotational force of the driving cam becomes zero. The rotational position of the driving cam and the axial position of the control shaft are held at a constant position. Thereby, the rotary place of the driving cam and the axial position of the control shaft component can be held in a fixed position.

### CROSS-REFERENCE TO RELATED APPLICATION

This application is based on Japanese Patent Applications No. 2012-239327 filed on Oct. 30, 2012, No. 2012-273349 filed on Dec. 14, 2012, and No. 2013-71867 filed on Mar. 29, 2013, the disclosures of which are incorporated herein by reference.

### TECHNICAL FIELD

The present disclosure relates to a driving device which converts a rotary motion of a power source into a reciprocate motion of a control shaft and adjusts a control amount of the control-subject according to an axial position of the control shaft. The present disclosure also relates to a control method of the same.

### BACKGROUND

Conventional driving device converts a rotary motion of a power source into a reciprocate motion of a control shaft by a driving cam and adjusts a control amount of the control-subject according to an axial position of the control shaft. In such a driving device, when the driving force of a power source is stopped, the driving cam and the control shaft are required to be held at a constant position against the load applied to the control shaft from the control-subject.

JP-2005-146865A shows a driving device having a driving cam of which peripheral surface is a circumference surface. A driving cam and a control shaft component can be held at a constant position by stopping the driving force at a condition where the circumference surface is engaged with a contacting portion.

In the driving device shown in JP-2005-146865A, a center shaft of the control shaft component, a center of the driving cam and a contacting point between the circumference surface and the contact portion (roller) are located on the same straight line. The driving cam receives no rotational force. A rotation of the driving cam is locked.

However, in the actual products, due to manufacturing size dispersion and backlashes, it is difficult to arrange the center shaft of the control shaft, the center of the driving cam, and the contacting point between the circumference surface and the contact portion on the same straight line. Therefore, when the driving force of a power source is stopped, it is likely that a rotational force is generated at the driving cam. An axial position of the control shaft may move.

### SUMMARY

It is an object of the present disclosure to provide a driving device which can hold a driving cam at a constant position when the driving force is stopped from a power source.

A driving device adjusts a control amount of a control-subject according to an axial position of a control shaft. The driving device includes a power source, a driving cam rotating around a cam shaft. A profile distance of an outer profile from a center is uneven. The driving device includes a contact portion which is biased by the control-subject so that the contact portion is in contact with an outer profile of the driving cam at a contacting point.

The driving device includes a supporting frame which supports the contact portion and reciprocates in a direction perpendicular to the cam shaft according to a variation of the outer profile of the driving cam and a control shaft which is coupled to the supporting frame to reciprocate therewith. The driving cam has a pocket portion at which the profile distance increase in a normal rotation direction and a reverse rotation direction.

### BRIEF DESCRIPTION OF THE DRAWINGS

The above and other objects, features and advantages of the present disclosure will become more apparent from the following detailed description made with reference to the accompanying drawings. In the drawings:

FIGS. 1A and 1B are schematic views showing an essential portion of a driving device according to a first embodiment;

FIG. 2 is a perspective view showing a driving device according to the first embodiment;

FIG. 3 is a schematic diagram showing a valve lift controller;

FIG. 4 is a cross-sectional view taken along line IV-IV in FIG. 3;

FIGS. 5A and 5B are schematic views showing a driving cam according to the first embodiment;

FIG. 6 is a schematic chart showing a comparative example of a driving cam;

FIGS. 7A to 7C are schematic views showing applied forces to the driving cam;

FIGS. 8A and 8B are charts for explaining a small-roll-control;

FIG. 9 is a time chart for explaining the small-roll-control;

FIGS. 10A and 10B are schematic views showing a driving cam according to the second embodiment;

FIGS. 11A and 11B are schematic views showing a driving cam according to the third embodiment;

FIGS. 12A and 12B are schematic views showing a driving cam according to the fourth embodiment;

FIG. 13 is a schematic view showing a driving cam according to the fifth embodiment;

FIGS. 14A and 14B are schematic views showing an essential portion of a driving device according to a sixth and a seventh embodiment;

FIGS. 15A and 15B are schematic views showing an essential portion of a driving device according to an eighth and a ninth embodiments; and

FIGS. 16A to 16C are schematic views showing an essential portion of a driving device according to another embodiment.

### DETAILED DESCRIPTION

Multiple embodiments will be described with reference to accompanying drawings.

[First Embodiment]

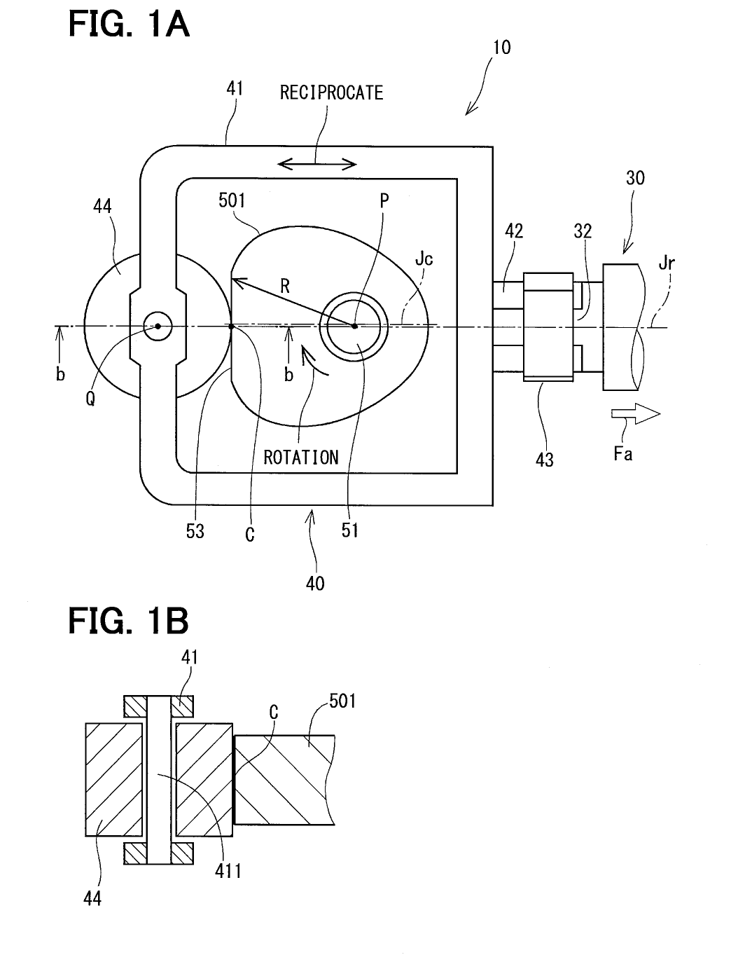

Referring to FIGS. 1 to 7, a first embodiment of a driving device will be described, hereinafter.

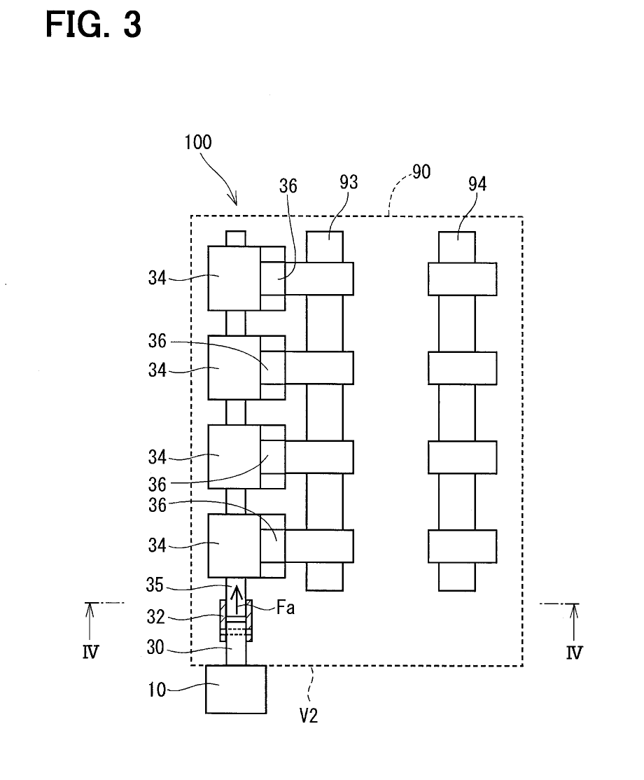

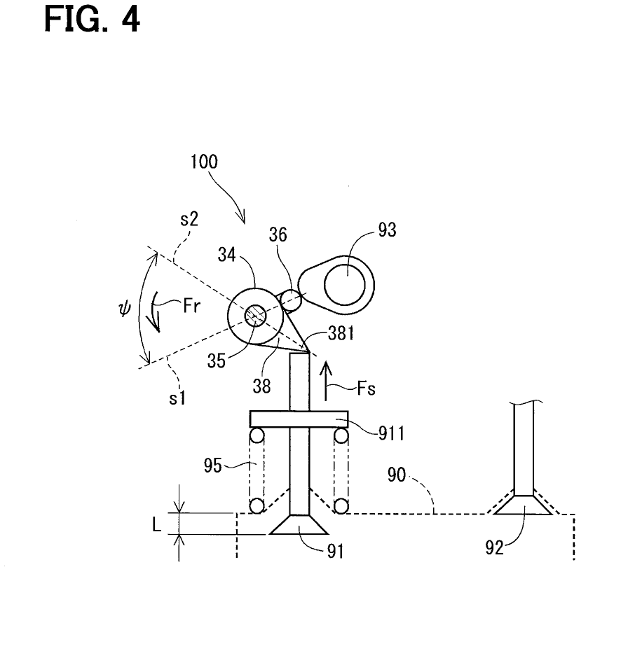

As shown in FIGS. 3 and 4, the driving device of present embodiment is used as a driving device 10 of a valve lift controller 100. The valve lift controller adjusts a lift amount “L” of an intake valve 91 of a 4-cylinder engine 90.

The valve lift controller 100 is comprised of the driving device 10 having a control shaft 30, an extended shaft 35 connected with the control shaft 30, a helical spline 34, a roller 36, and an oscillating cam 38.

An inner wall of the helical spline 34 is engaged with an outer surface of the extended shaft 35. The helical spline 34 rotates along with the reciprocating motion of the control shaft 30 and the extended shaft 35. Thereby, an opening angle of an imaginary line “s1” and an imaginary line “s2” is varied. The imaginary line “s1” connects a center of the extended shaft 35 and the roller 36. The imaginary line “s2” connects the center of the extended shaft 35 and a nose 381 of the oscillating cam 38.

The roller 36 is in contact with a cam of an intake cam shaft 93. Along with a rotation of the intake cam shaft 93, the oscillating cam 38 swings. The nose 381 of the oscillating cam 38 is in contact with an end of the intake valve 91. According to a swing motion of the oscillating cam 38, the intake valve 91 is lifted up. Therefore, the lift amount “L” of the intake valve 91 can be adjusted by adjusting the axial position of the control shaft 30 and the extended shaft 35 to vary the opening angle “ψ”.

In the present embodiment, the valve lift controller 100 does not control a lift amount of an exhaust valve 92.

The intake valve 91 has a flange portion 911. A valve spring 95 is in contact with the flange portion 911 to bias the intake valve 91 upward with a biasing force “Fs”. This biasing force “Fs” pushes up the nose 381 of the oscillating cam 38, and generates a rotational force “Fr” in counter clockwise direction to the helical spline 34. In the present embodiment, the rotational force “Fr” of the helical spline 34 is converted to a load “Fa” which pulls the extended shaft 35 and the control shaft 30.

As above, from the helical spline 34, the load “Fa” is applied to the control shaft 30 in such a manner as to be moved away from the driving cam 501.

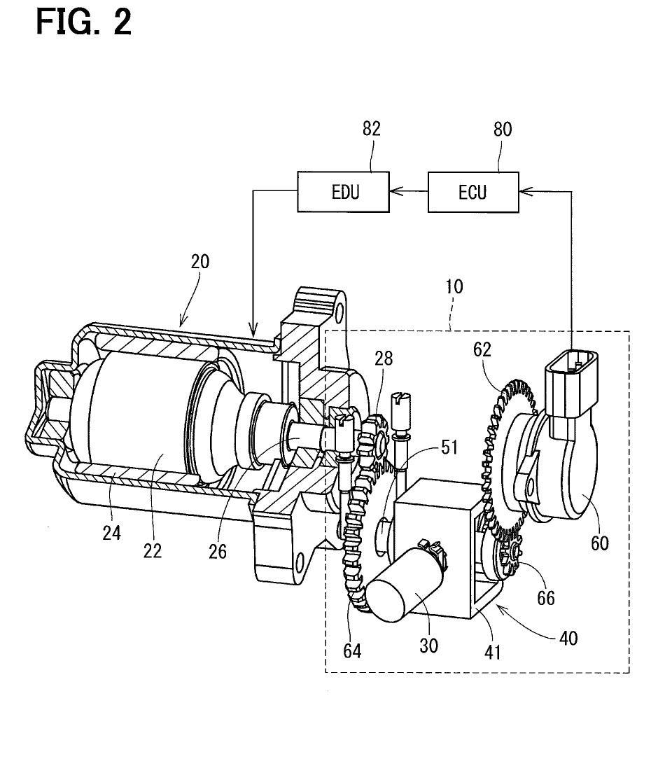

Referring to FIGS. 1A, 1B and 2, the configuration of the driving device 10 will be described hereinafter.

The driving device 10 has a motor 20 as a “power source”, the control shaft 30, a supporting frame 41, the roller 44, a driving cam 501 and an angle sensor 60. Based on command signals from an ECU (electronic control unit) 80 and an EDU (drive circuit) 82, the motor 20 generates the rotational driving force.

The motor 20 is a DC motor having a rotator 22 and a permanent magnet 24. A motor gear 28 is coupled to an end of a motor shaft 26.

The control shaft 30 and the motor shaft 26 are arranged at right angle. One end 32 of the control shaft 30 is connected to a coupling portion 42 of the supporting frame 41 through a clip 43. The supporting frame 41 is square shaped and is eccentric to a rotational center “P” of the driving cam 501. As shown in FIG. 1B, the cylindrical roller 44 is supported by the supporting frame 41 by using of a pin 411. A center “Q” of the roller 44 is arranged on a first axis “Jr” which is a center axis of the control shaft 30. The supporting frame 41 and the roller 44 constitute a transfer portion 40 which converts the rotary motion of the driving cam 501 into a reciprocating motion. The reciprocating motion is transmitted to the control shaft 30.

In the driving cam 501, a profile distance “R” between outer line of the driving cam 501 and a rotational center “P” is not constant. A rotational center “P” of the cam shaft 51 and the driving cam 501 exists inside of the supporting frame 41. The roller 44 is in contact with the driving cam 501 at a contacting point “C”. Along with a rotation of the driving cam 501, the profile distance “R” at the contacting point “C” varies. Thus, the roller 44, the supporting frame 41 and the control shaft 30 reciprocate in horizontal direction in FIG. 1.

It should be noted that the contact point “C” is a contact line in three dimensions. An axis passing through the point “P” and is parallel to the first axis “Jr” is defined as a second axis “Jc”. The driving device 10 is assembled in such a manner that the second axis “Jc” overlaps with the first axis “Jr”. At this time, the center axis of the control shaft 30, the center “P” of the driving cam 501, the contacting point “C” and the center “Q” of the roller 44 are arranged on the same straight line.

However, in an actual product, the first axis “Jr” deviates from the second axis “Jc” The above center points may not be on the same straight line.

The cam shaft 51 is substantially parallel with the shaft 26 of the motor 20. A cam gear 64 is attached to one end of the cam shaft 51 and another cam gear 66 is attached to the other end of the cam shaft 51. The cam gear 64 is engaged with the motor gear 28.

The angle sensor 60 has a sensor gear 62 which is engaged with the cam gear 66. The angle sensor 60 detects the rotating angle of the sensor gear 62 by magnetism detecting elements.

The ECU 80 receives detected signals from the angle sensor 60, an accelerator position sensor and other sensors. Based on these signals, the ECU 80 transmits control signals to the EDU 82. The EDU 82 drives the motor 20 based on the control signals from the ECU 80.

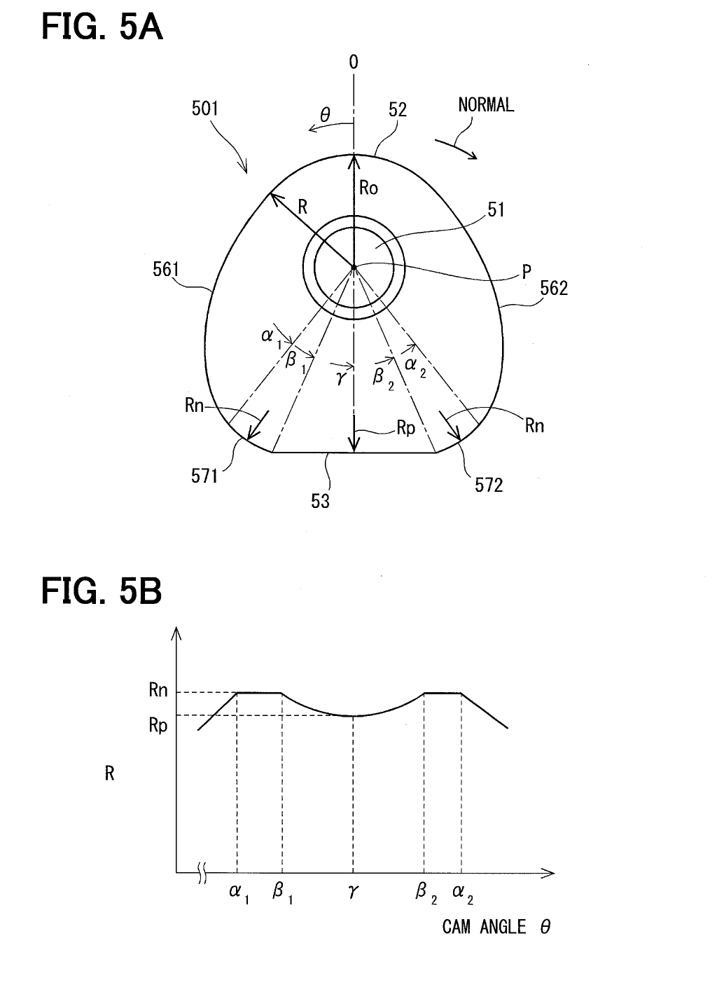

Referring to FIGS. 5A and 5B, the specific configuration of the driving cam 501 will be described, hereinafter.

As shown in FIG. 5A, the driving cam 501 is comprised of a curved-surface part and a flat-surface part around the cam shaft 51. The curved-surface part is comprised of a base portion 52, gradually-varying portions 561, 562, and adjacent portions 571, 572. The flat-surface part is a pocket portion 53.

In FIG. 5A, an upward direction relative to a center point “P” is defined as a reference axis “x” of cam angle θ. The counter clockwise direction of the cam angle A is defined as positive. The driving cam 501 rotates in the normal rotation direction which is a clockwise rotation in FIG. 5A.

The base portion 52 is formed both sides of the reference axis “x” and includes a based profile distance “Ro” which is a minimum value of the profile distance “R”. The pocket portion 53 is formed at 180 deg of cam angle θ. At the pocket portion 53, the profile distance “R” increases in the normal rotation direction and in the reverse rotation direction.

At the left side of the reference axis “x”, the gradually-varying portion 561 and the adjacent portion 571 are formed between the base portion 52 and the pocket portion 53. At the gradually-varying portion 561, the profile distance “R” gradually increases when the driving cam 501 rotates in the normal rotation direction. The adjacent portion 571 is adjacent to the pocket portion 53. At the adjacent portion 571, the profile distance “R” is constant and is a maximum value “Rn”.

The gradually-varying portion 562 and the adjacent portion 572 are symmetrically formed with respect to the reference axis “x”. At the gradually-varying portion 562, the profile distance “R” gradually decreases when the driving cam 501 rotates in the normal rotation direction. The cam angle θ of a boundary between the gradually-varying portion 561 and the adjacent position 571 is “α1”. The cam angle θ of a boundary between the adjacent portion 571 and the pocket portion 53 is “β1”. The cam angle θ of a boundary between the pocket portion 53 and the adjacent portion 572 is “β2”. The cam angle θ of a boundary between the adjacent portion 572 and the gradually-varying portion 562 is “α2”. Moreover, at the pocket portion, a minimum cam angle is “γ” and the minimum profile distance is “Rp”. The relation between cam angle θ and the profile distance “R” is shown in FIG. 5B.

An operation of the driving device 10 will be described hereinafter. When the motor 20 rotates based on a command signal from the EDU 82, the torque of the motor 20 is transmitted to the cam shaft 51 and the driving cam 501 through the motor gear 28 and the cam gear 64. When the driving cam 501 rotates, the supporting frame 41 reciprocates according to the variation of the profile distance “R” at the contacting point “C”. The control shaft 30 and the extended shaft 35 also reciprocate.

According to the axial position of the control shaft 30 and the extended shaft 35, the helical spline 34 of the valve lift controller 100 rotates. The opening angle “ψ” varies according to the positions of the roller 36 and the oscillating cam 38. The lift amount “L” of the intake valve 91 changes.

When the engine 90 is shut down, the EDU 82 drives the motor 20 so that the pocket portion 53 is brought into contact with the roller 44. Then, the motor 20 is deenergized. Since the roller 44 is in contact with the pocket portion 53, the driving cam 501 receives no rotational force. That is, the driving cam 501 is locked. The rotational position of the driving cam 501 and the axial position of the control shaft 30 are held at the constant position.

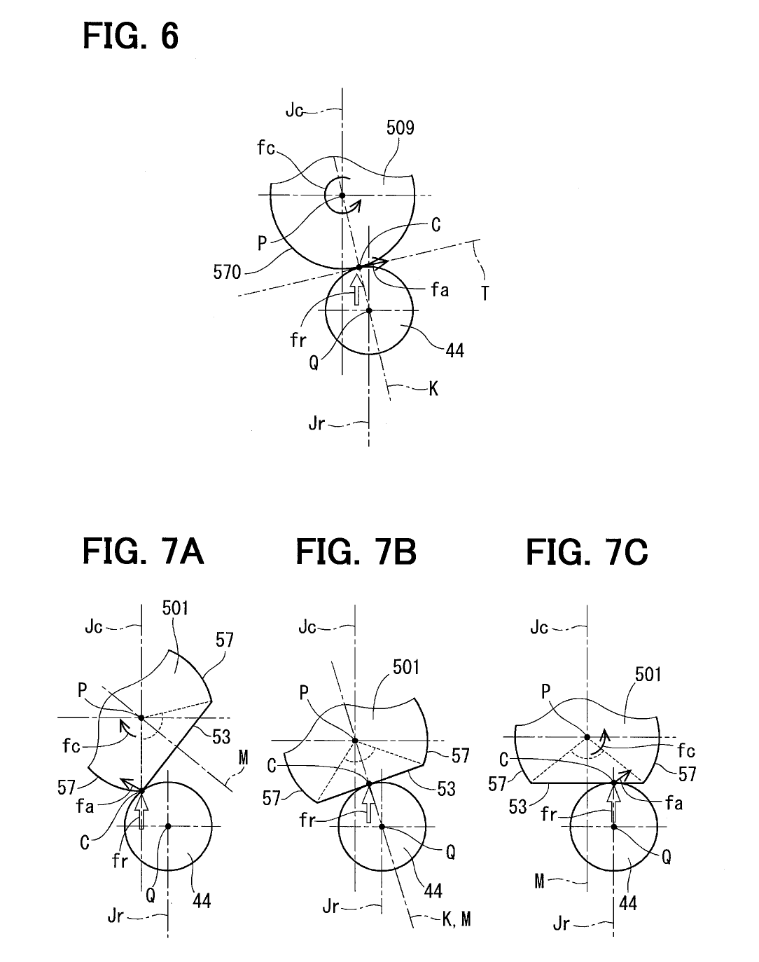

Referring to FIG. 6 and FIGS. 7A to 7C, an advantage of the driving device 10 will be explained. FIG. 6 shows a comparative example of a driving cam 509 which has no pocket portion. A concentric circle portion 570 is in contact with the roller 44. FIGS. 7A to 7C shows the driving cam 501 of the present embodiment. The driving cam 501 has the pocket portion 53. The roller 44 is in contact with the pocket portion 53. FIG. 6 and FIGS. 7A to 7C show a rotational force “fc” which is generated when the first axis “Jr” deviates from the second axis “Jc”.

FIG. 6 shows that the first axis “Jr” shifts from the second axis “Jc” to right side. The contacting point “C” is on a common center line “K”. The contacting point “C” shifts from the second axis “Jc” to right side. Since the roller force “fr” of the roller 44 is parallel to the first axis “Jr” relative to the contacting point “C”. Thus, a force “fa” is generated on the contacting point “C” along a common tangent “T” in right direction in FIG. 6. The force “fa” generates a rotational force “fc” to the driving cam 509 in the counter clockwise direction.

When the first axis “Jr” shifts from the second axis “Jc” to left side, the contacting point “C” shifts from the second axis “Jc” to left side. As a result, the rotational force “fc” is generated to the driving cam 509 in the clockwise rotation.

In the comparative example, only when the second axis “Jc” and the first axis “Jr” are on the same line, the rotational force “fc” becomes zero. When the second axis “Jc” and the first axis “Jr” are not on the same line, the rotational force “fc” is always generated at the contacting point “C”. Thus, when the motor 20 is stopped, the rotational position of the driving cam 509 can not be held.

In FIGS. 7A to 7C, a pocket-portion center line “M” is a straight line which passes through a rotational center “P” of the driving cam 501. Since the pocket portion 53 is a flat surface, the pocket-portion center line “M” crosses the pocket portion 53 at right angles. FIG. 7A shows a case where the contacting point “C” is on an edge of the pocket portion 53. At this time, the contacting point “C” is located at left side relative to the pocket-portion center line “M”. The force “fa” is applied to the contacting point “C” based on the roller force “fr”. The force “fc” is applied to the driving cam 501 in the clockwise rotation.

When the driving cam 501 rotates in the clockwise rotation from the position of FIG. 7A to the position of FIG. 7B, the pocket-portion center line “M” and the common center line “K” are on the same line. At this time, the contacting point “C” moves on the pocket portion 53 to be on the pocket-portion center line “M” and the common center line “K”. This position is equivalent to the minimum cam angle “γ” shown in FIG. 5. At this position, the rotational force “fc” becomes zero on the driving cam 501.

It is supposed that the driving cam 501 rotates in the clockwise rotation from the position of FIG. 7B to the position of FIG. 7C. Since the contacting point “C” is positioned at right side relative to the pocket-portion center line “M”, the force “fa” is applied to the contacting point “C” rightward. The force “fa” generates a rotational force “fc” on the driving cam 501 in the counter clockwise direction. Thus, the driving cam 501 rotates to the position shown in FIG. 7B. The position of the driving cam 501 becomes stable at the position shown in FIG. 7B, where the rotational force “fc” is zero. The above function is referred to as “pocket effect.”

According to the present embodiment, even when there is a deviation between the first axis “Jr” and the second axis “Jc” and when the motor 20 is stopped, the driving cam 501 is locked in a condition where the pocket portion 53 is in contact with the roller 44. As a result, the rotational position of the driving cam 501 and the axial position of the control shaft 30 can be held at a constant position.

Therefore, when the driving device 10 is applied to the valve lift controller 100, a valve lift amount of the intake valve 91 can be held correctly. Thus, the startability of the engine 90 is ensured and the fuel economy is enhanced.

Since the pocket portion is a flat surface, the driving cam 501 can be easily manufactured. Moreover, since the cylindrical roller 44 is in contact with the flat pocket portion 53, the Hertzian stress is decreased and the contact pressure is also decreased.

Even if the axis of the roller 44 and the axis of the driving cam 501 are twisted, the contact pressure can be maintained. Therefore, the heat treatment is unnecessary to improve the hardness of the roller and the cam.

In addition, the adjacent portion 57 is circular with respect to the point “P”. That is, since the profile distance “Rn” is constant, the axial position of the control shaft 30 can be maintained. Thereby, even if the driving cam 501 rotates over the pocket portion 53 due to external forces, the adjacent portion 57 functions as a buffer area. Thus, axial position of the control shaft 30 is not rapidly changed.

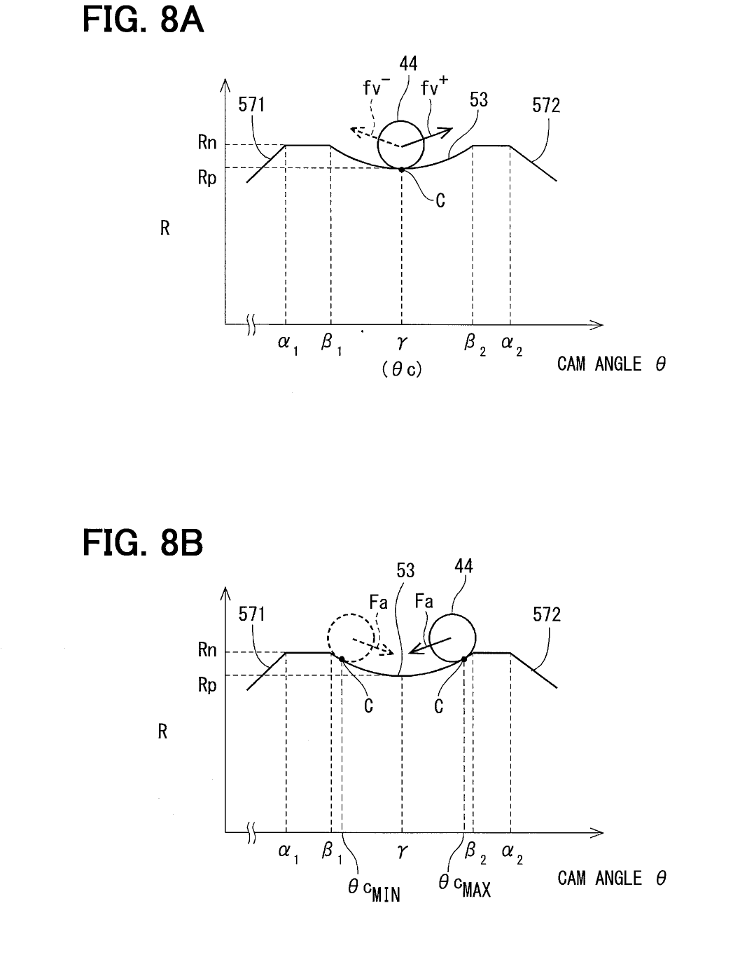

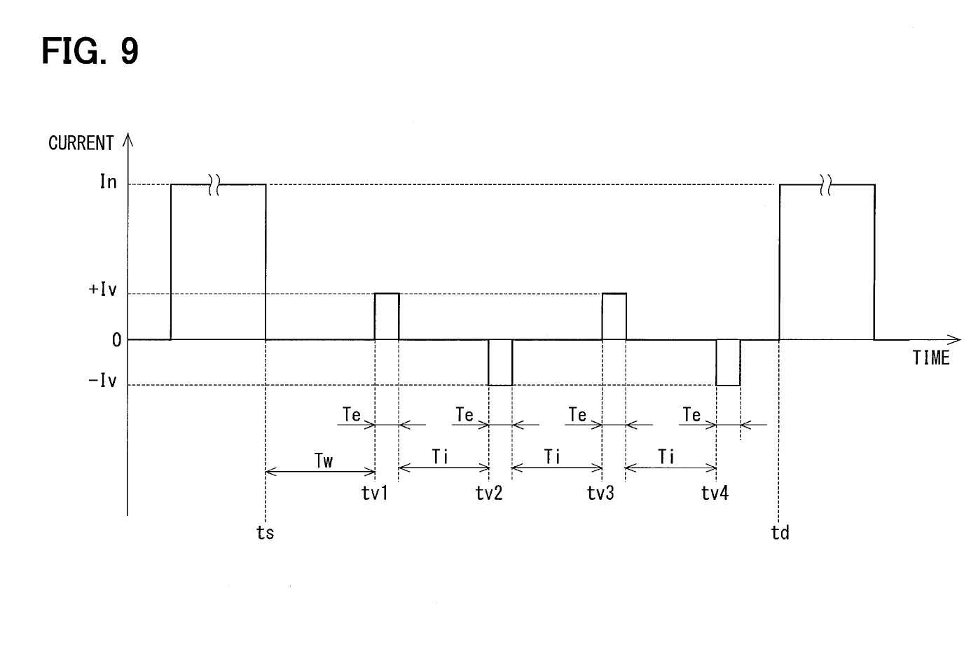

Referring to FIGS. 8A, 8B and 9, a control method of the motor 20 will be explained. FIGS. 8A and 8B schematically show a position of the contacting point “C” on the pocket portion 53. The roller 44 is shown by a solid line or a dashed line. FIG. 9 is a time chart showing the drive electric current which flows through the motor 20.

When the motor 20 is stopped, the rotational position of the driving cam 501 is held at a specified position by the pocket effect. Specifically, a contact-point angle θc on the pocket portion 53 is always the minimum cam angle “γ” in a stable condition. When the driving cam 50 and the roller 44 are always in contact with each other at the same position, it is likely that this contact position will be intensively worn.

While the ECU 80 does not perform a usual driving in which the control shaft 30 is axially moved, the ECU 80 performs a small-roll-control to vary the contact-point angle θc. When the usual driving is stopped at a time “ts” in FIG. 9, an inertial vibration will attenuate gradually. The time period until the stable condition is defined as a waiting time “Tw”.

As shown in FIG. 8A, at the time “tv1”, the contact-point angle θc agrees with the minimum cam angle “γ”. When the ECU 80 applies the positive drive electric current +Iv to the motor 20 at the time “tv1”, a driving force “fv+” is generated to rotate the driving cam 501 slightly. The contact-point angle θc is slightly increased from the minimum can angle “γ”. The drive electric current “+Iv” is significantly smaller than the normal drive current In. When the time period “Te” has passed, the drive electric current “+Iv” is stopped. Thus, the contacting point “C” remains on the pocket portion 53. That is, as shown in FIG. 8B, the maximum contact-point angle θcMAX in the small-roll-control is smaller than the cam angle β2.

Then, when the contact-point angle θc is decreased from the maximum angle θcMAX to the minimum can angle “γ”, no driving current is supplied to the motor 20. Due to the load “Fa” applied to the roller 44 from the helical spline 34, the driving cam 501 rotates in such a manner that the contact-point angle θc is decreased to the minimum cam angle “γ”.

After the drive electric current +Iv is stopped and when an interval “Ti” has passed at the time “tv2”, the contact-point angle θc agrees with the minimum cam angle “γ”. When the ECU 80 applies the negative drive electric current “−Iv” to the motor 20 at the time “tv2”, a driving force “fv−” is generated to rotate the divining cam 501 slightly. The contact-point angle θc is slightly decreased from the minimum can angle “γ”. The contacting point “C” remains on the pocket portion 53. That is, the minimum contact-point angle θcMIN in the small-roll-control is larger than the cam angle β1.

Then, when the contact-point angle θc is increased from the minimum angle θcMIN to the minimum can angle “γ”, no driving current is supplied to the motor 20. The driving cam 501 rotates in such a manner that the contact-point angle θc is increased to the minimum cam angle “γ”.

After that, when the interval “Ti” elapsed, the positive driving current +Iv is supplied to the motor 20 at the time “tv3” and the negative driving current −Iv is supplied to the motor 20 at the time “tv4”. That is, when the contact-point angle θc is increased or decreased against the load “Fa”, the motor 20 is driven. When the contact-point angle θc comes close to the minimum cam angle “γ” by using of the load “Fa”, the motor 20 is not driven.

As described above, by performing the small-roll-control, the contact point between the driving cam 501 and the roller 44 are varied. Thus, it is avoided that only specific portion is worn intensively. Moreover, only when increasing or decreasing the contact-point angle θc, the motor 20 is driven. Thus, the electric power consumption can be reduced. Also, by setting the time “Tw” and the interval “Ti”, the electric power consumption can be reduced.

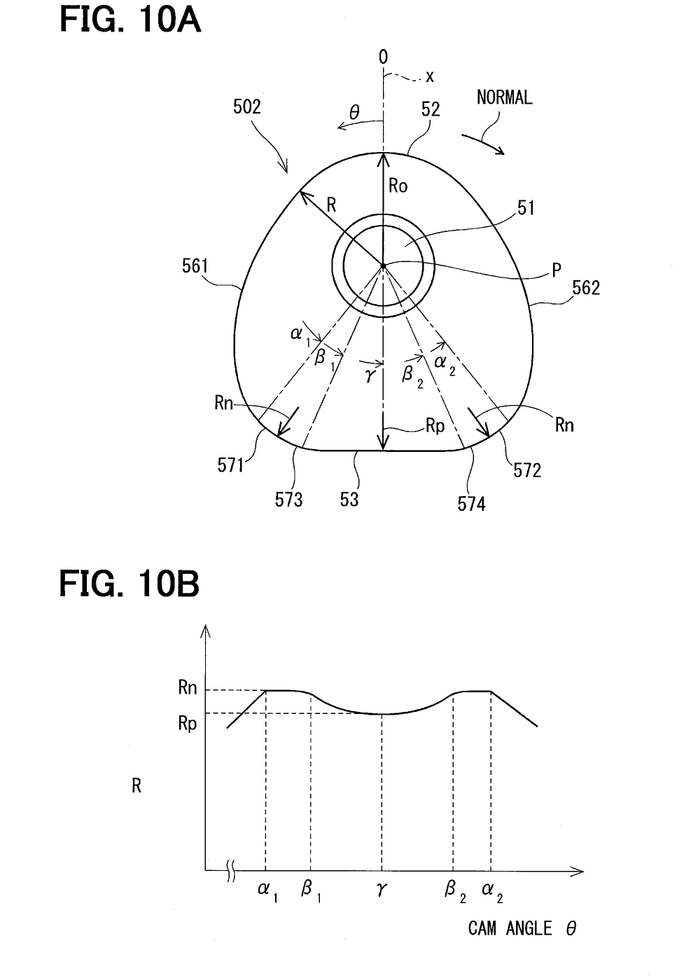

Referring to FIGS. 10 to 13, a second to fifth embodiments of a driving device will be described, hereinafter. In the second to fifth embodiments, the shape of the driving cam is modified relative to the first embodiment. Moreover, each embodiment has the pocket effect, and the ECU 80 performs the small-roll -control. The substantially same parts and the components as the first embodiment are indicated with the same reference numeral and the same description will not be reiterated.

[Second Embodiment]

As shown in FIG. 10A and 10B, a driving cam 502 has round portions 573, 574 between the pocket portion 50 and the adjacent portion 571, 572. The both ends of the pocket portion 50 can be smoothly connected to the adjacent portion 571, 572 through the round portions 573, 574.

[Third Embodiment]

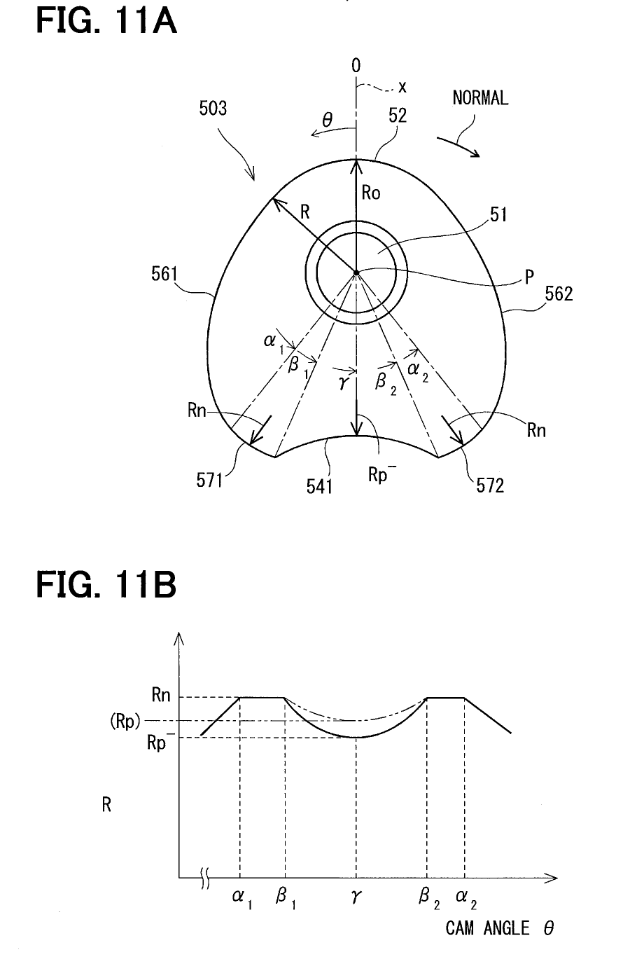

FIG. 11A and 11B show a driving cam 503 of third embodiment. The pocket portion 541 is a concave curve. The profile distance “RP-” at the minimum can angle “γ” is smaller than the profile distance “Rp” of the first embodiment. Thus, the pocket effect is further improved.

[Fourth Embodiment]

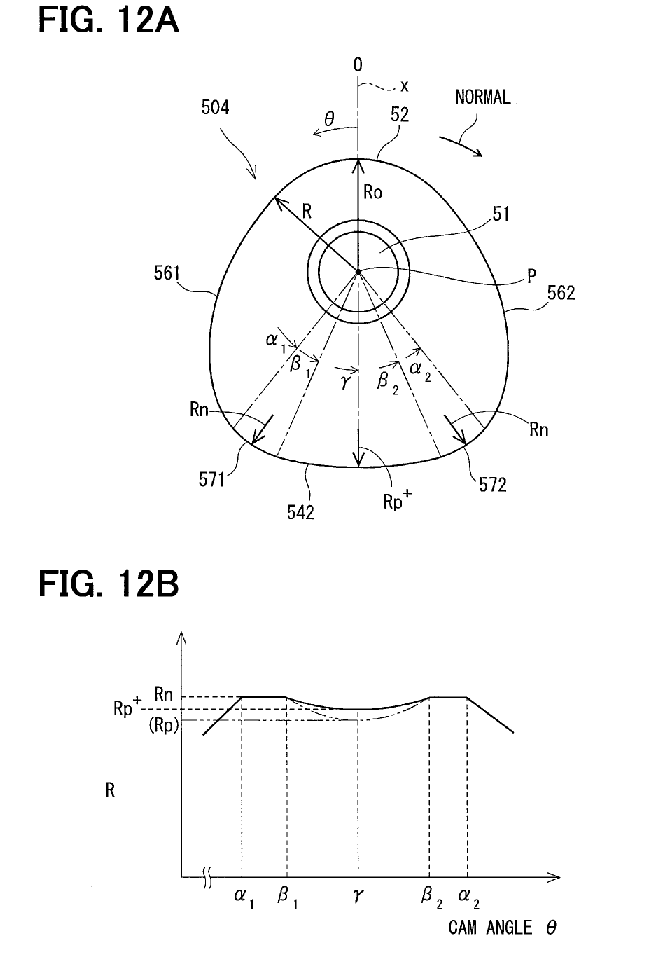

FIG. 12A and 12B show a driving cam 504 of fourth embodiment. The pocket portion 542 is a convex curve. The profile distance “RP+” at the minimum can angle “γ” is larger than the profile distance “Rp” of the first embodiment. The profile distance “RP+” is smaller that the profile distance “Rn” of the adjacent portions 571, 572. Thus, the pocket effect is further improved.

[Fifth Embodiment]

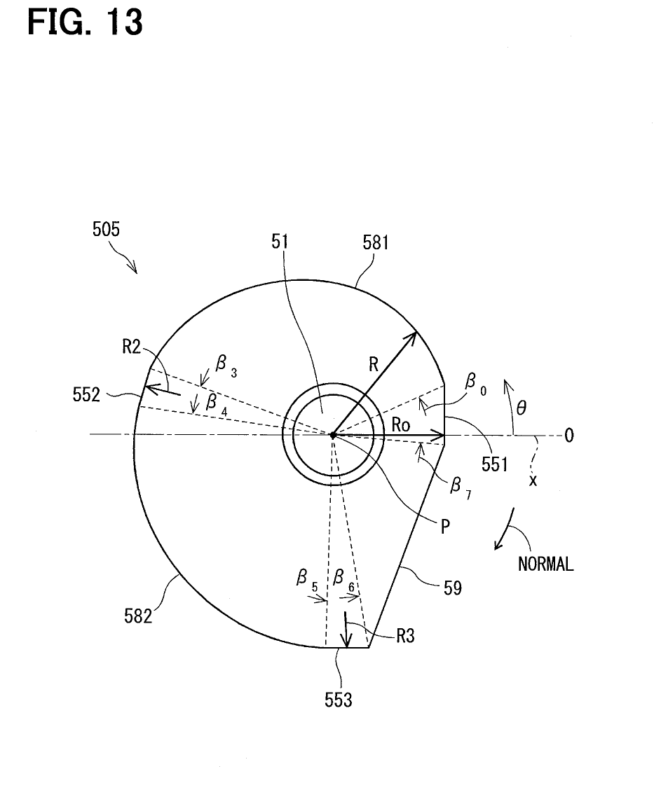

FIG. 13 shows a driving cam 505 of a fifth embodiment. The driving cam 505 has three flat pocket portions 551, 552, and 553. A reference axis “x” of the cam angle extends from the center point “P”. The counter clockwise direction is defined as positive rotation of the cam angle θ. The driving cam 505 rotates in a clockwise rotation in FIG. 13.

The first pocket portion 551 is formed between the cam angle β7 and the cam angle β0. The first pocket portion 551 includes the reference axis “x” and a base profile distance “Ro”. The second pocket portion 552 is formed between the cam angle β3 and the cam angle β4. The second pocket portion 552 has a profile distance “R2”. The third pocket portion 553 is formed between the cam angle β5 and the cam angle β6. The third pocket portion 552 has a profile distance “R3”.

The profile distance “R2” of the second pocket portion, the profile distance “R3” of the third pocket portion and the base profile distance “Ro” have following relationship:

“R3>R2>Ro”

The gradually-varying portions 581 and 582 are formed between the first pocket portion 551 and the second pocket portion 552 and between the second pocket portion 552 and the third pocket portion 553. Moreover, a connecting portion 59 is formed between the third pocket portion 553 and the first pocket portion 551. At the connecting portion 59, the profile distance “R” is rapidly decreased.

When the motor 20 is stopped, the driving cam 505 is stopped at a cam angle corresponding to one of the three pocket portions 551, 552, 553. The axial position of the control shaft 30 can be maintained at one of the most retard position, the intermediate position, or the most advance position.

According to the moving direction of the control shaft 30, the polarity of the driving current “In” is reversed.

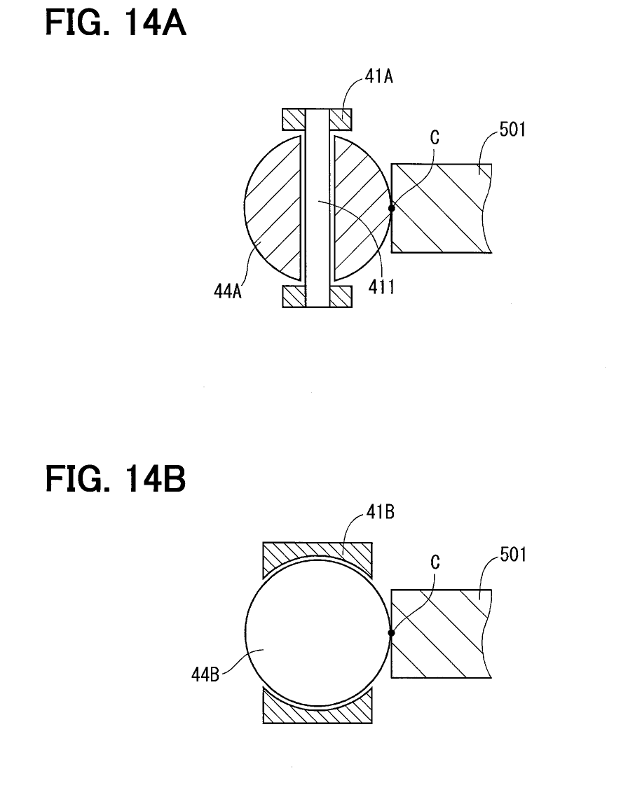

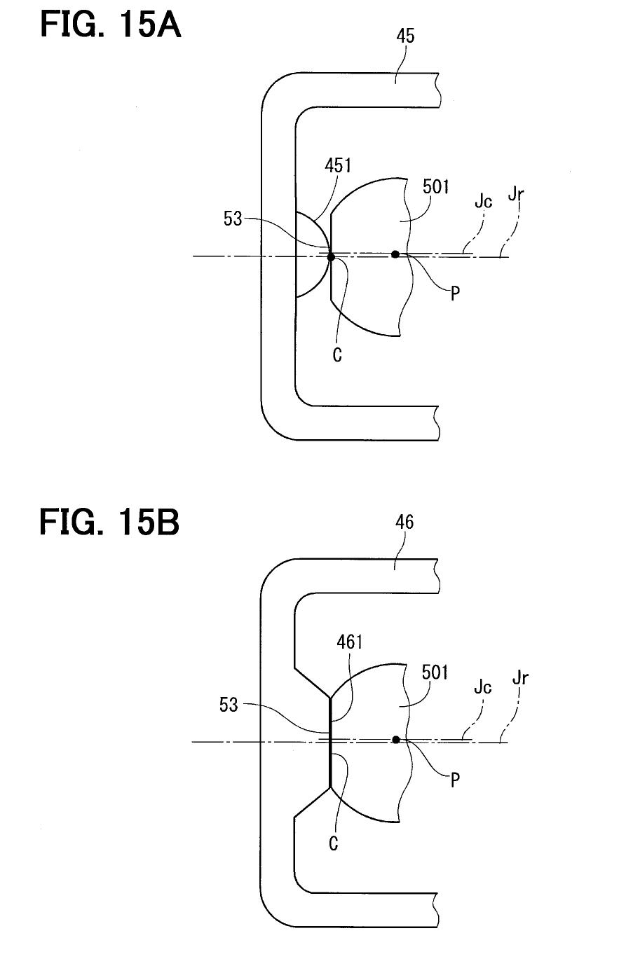

Referring to FIGS. 14 and 15, a sixth to a ninth embodiments of a driving device will be described, hereinafter. In the sixth to ninth embodiments, the shapes of the supporting frame and the roller are modified relative to the first embodiment.

[Sixth and Seventh Embodiments]

A sixth embodiment and a seventh embodiment will be described with reference to FIGS. 14A and 14B. FIG. 14A and 14B are cross sectional views of the roller.

As shown in FIG. 14A, the roller 44A of the sixth embodiment is a sphere. The roller 44A is supported by the supporting frame 41A with a pin 411. The roller 44A rotates around the pin 411. The roller 44A and the driving cam 501 are in contact with each other at a contacting point “C”. The sphere roller 44A can absorb the three-dimensional axial gap of the driving cam 501. The frictional resistance can be decreased. Since the roller 44A is sphere, a profile distance between the driving cam 501 and the roller 44A is always constant even if the contacting point “C” moves.

As a modification of the sixth embodiment, only a belt-like portion of the roller 44A on which the driving cam 501 is in contact may be convex curve surface.

FIG. 14B shows a seventh embodiment which has a ball 44B instead of the roller. The supporting frame 41 B has spherical concave portions to support the ball 44B. The ball 44B can absorb the three-dimensional axial gap of the driving cam 501. In the sixth and the seventh embodiment, the driving cam 501 to 504 of the second to the fourth embodiment can be employed.

[Eighth and Ninth Embodiments]

An eighth embodiment and a ninth embodiment will be described with reference to FIG. 15A and 15B. FIGS. 15A and 15B show the supporting frames 45, 46.

The eighth embodiment and the ninth embodiment have no roller 44. Ends of the supporting frames 45, 46 are directly in contact with the pocket portion 53. The supporting frame 45 has a spherical or convex curved end 451 which is in contact with the pocket portion 53. The three-dimensional axial gap of the driving cam 501 can be absorbed.

In the ninth embodiment shown in FIG. 15B, the supporting frame 46 has a flat end 461 which is in contact with the pocket portion 53. When the motor 20 is stopped, the driving cam 501 is rotated so that the pocket portion 53 is in contact with the flat end 461. In the eighth embodiment and the ninth embodiment, the supporting frames 45, 46 have “contact portion” and “supporting portion”.

[Other Embodiments]

(i) The shape of the driving cam is not limited to above described embodiment. In the fifth embodiment, the number of the pocket portion is not limited to three.

(ii) In the above embodiments, the load “Fa” is applied in a direction to pull the control shaft 30. The load “Fa” may be applied in a direction to push the control shaft 30.

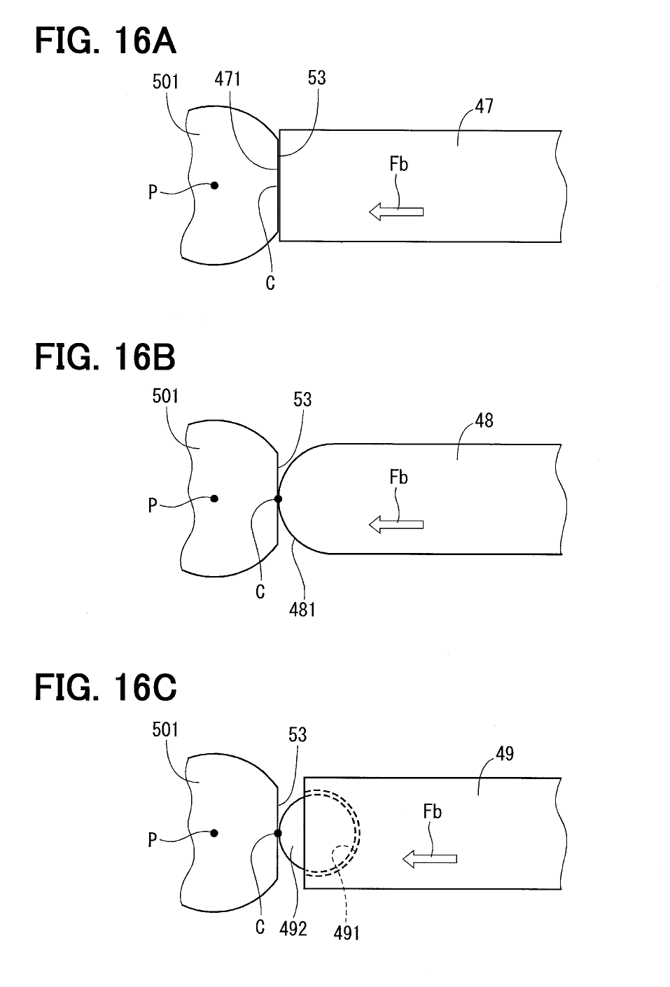

In FIGS. 16A to 16C, the load “Fb” is applied so as to push the control shaft 47, 48, 49. The control shaft 47, 48, 49 reciprocates in a horizontal direction along with a rotation of the driving cam 501.

FIG. 16A shows that the control shaft 47 has a flat tip end 471 and the flat tip end 471 is in contact with the pocket portion 53. The same advantages as those in the ninth embodiment can be obtained.

FIG. 16B shows that the control shaft 48 has a curved end 481 and the curved end 481 is in contact with the pocket portion 53. The same advantages as those in the eighth embodiment can be obtained.

In the configuration shown in FIGS. 16A and 16B, since the control shaft 47, 48 is directly in contact with the driving cam 501, a variation of the position can be reduced. The control shaft 47, 48 has a contacting portion, a supporting portion and a control shaft portion.

FIG. 16C shows that the control shaft 49 has a ball 492 in a concave portion 492. The ball 492 and the pocket portion 53 are in contact with each other at the contacting point “C”. The same advantages as those in the sixth embodiment and the seventh embodiment can be obtained.

(iii) A power source may be a DC motor, an AC motor, a hydraulic motor.

(iv) In the small-roll-control, the energizing direction may be changed. The waiting time “Tw” and the interval “Ti” can be changed suitably.

(v) The valve lift adjusting device may adjust the lift amount of not only an intake valve but also an exhaust valve.

(vi) The present invention is not limited to the embodiments mentioned above, and can be applied to various embodiments.

What is claimed is:

1. A driving device which adjusts a control amount of a control-subject according to an axial position of a control shaft, comprising:
a power source;
a driving cam rotating around a cam shaft, the driving cam having an outer profile of which profile distance from a center is uneven;
a contact portion which is biased by the control-subject so that the contact portion is in contact with the outer profile of the driving cam at a contacting point;
a supporting frame which supports the contact portion and reciprocates in a direction perpendicular to the cam shaft according to a variation of the outer profile of the driving cam;
a control shaft which is coupled to the supporting frame to reciprocate therewith;
wherein:
the driving cam has a pocket portion at which the profile distance increases in a normal rotation direction and a reverse rotation direction.

2. A driving device according to claim 1, wherein
the pocket portion is a flat surface.

3. A driving device according to claim 1, wherein
the driving cam has a plurality of pocket portions.

4. A driving device according to claim 1, wherein
the driving cam has an adjacent portion adjacent to the pocket portion, and the profile distance of the adjacent portion is constant.

5. A driving device according to claim 1, wherein
the pocket portion has a boundary of the adjacent portion, and a curvature of the boundary is continuously changed.

6. A control method for controlling a driving device according to claim 1, wherein
while the control shaft is not driven to move in its axial direction, a driving force of the power source is controlled in such a manner that a contacting angle of the driving cam at the pocket portion is varied with time.

7. A control method according to claim 6, wherein
when the contacting angle is increased or decreased from the minimum cam angle at which the profile distance is minimum, the driving force of the power source is generated, and
when the contacting angle comes close to the minimum cam angle, the driving force of the power source is made zero.
